(19) United States
(12) Patent Application Publication
(10) Pub. No.: US 2010/0270072 A1
(43) Pub. Date: Oct. 28, 2010

(54) Systems and Methods of Protecting a Utility Line from a Penetrating Object

(75) Inventor: Jillian M. Frenkel, Roswell, GA (US)

Correspondence Address: SUTHERLAND ASBILL & BRENNAN LLP, 999 PEACHTREE STREET, N.E., ATLANTA, GA, 30309, US

(73) Assignee: ONE SMART CHICK, LLC, Roswell, GA (US)

(21) Appl. No.: 12/772,503

(22) Filed: May 3, 2010

Related U.S. Application Data
(63) Continuation-in-part of application No. 11/780,857, filed on Jul. 20, 2007, now Pat. No. 7,762,032.
(60) Provisional application No. 61/174,578, filed on May 1, 2009.

(51) Int. Cl. H02G 3/34; B23P 19/04

(52) U.S. Cl. 174/507; 29/428

(57) ABSTRACT

Systems and methods can protect a utility line from a penetrating object. In one embodiment, a method includes positioning a utility line protection plate between studs of a wall, covering at least a portion of the utility line with the utility line protection plate, and mounting the utility line protection plate between the studs.

### CROSS-REFERENCE TO RELATED APPLICATION

The present nonprovisional application is a continuation-in-part of U.S. Nonprovisional application Ser. No. 11/780,857, filed Jul. 20, 2007 and entitled “Systems and Methods for Providing a Utility Line Protection Plate,” which is incorporated by reference herein in its entirety. The present nonprovisional application also claims priority to U.S. Provisional Application Ser. No. 61/174,578, filed May 1, 2009 and entitled “Systems and Methods for Protecting a Utility Line from a Penetrating Object,” which also is incorporated by reference herein in its entirety.

### TECHNICAL FIELD

The present disclosure generally relates to systems and methods for protecting a utility line, and more particularly relates to systems and methods for protecting a utility line from a penetrating object, such as a nail or screw.

### BACKGROUND

In some instances, a builder or contractor installing siding, brick, or other wall-mounted materials may be careless in identifying specific locations of utility lines within a wall. In these instances, the builder or contractor may drive nails, bolts, or other penetrating objects into the wall, which may inadvertently puncture or otherwise damage a utility line within the wall. Sometimes the damage may go unnoticed as construction continues. Costly repairs and re-work may be needed including, but not limited to, drywall, paint, trim, flooring, mold remediation, and welding. The same problems may arise after the house is constructed, such as when improvements or alterations are completed by or on behalf of the homeowner. An improvement as simple as an installed towel rack may damage a utility line in a substantial manner. In the case of gas and electrical lines in particular, the damaged utility line may create a risk of harm to the homeowner and other occupants.

Conventional nail plates exist for protecting utilities in a wall. These conventional nail plates typically protect a portion of the utility line that passes through the wall stud. In particular, the conventional nail plate attaches to the wall stud adjacent to the utility, covering a location on the wall stud through which the utility line passes. Thus, conventional nail plates do not protect large portions of the utility line, such as those portions that are between studs. Conventional nail plates also are not suited for vertically extending utility lines, which do not pass through the wall studs.

Further, conventional plates may be relatively small and may not suitably protect the utilities in the wall. In these instances, it may be necessary to install numerous nail plates to protect the utilities within a wall. The use of multiple, rather small plates can be time consuming to install since a contractor must mount each relatively small plate in the wall and over the utilities. If the contractor or builder uses multiple plates, each of the plates must be closely aligned or there may be exposed portions of utilities, which will remain unprotected from possible strikes from nails, bolts, or penetrating objects.

One type of conventional nail plate, a box nail plate, includes a series of spikes adjacent to the edges of the box nail plate. The box nail plate, via the spikes, can be driven into the surface of a wood stud over the location where an internal utility wire passes through the wood stud. In some instances, the spikes may be prone to bending or deflection if the box nail plate is not properly installed. In many instances, the box nail plate only protects the electrical wire in a relatively small area, and does not protect the remaining portion of the electrical wire, which can be a much greater length than that covered by the box nail plate. Even though multiple box nail plates can be used to cover other portions of the electrical wire, the associated spikes of the box nail plate are primarily suitable for mounting against a wood stud or other surface along which the electrical wire is located. Thus, the use of the box nail plate and similar types of nail plates to protect electrical wires or other types of utilities in other locations within a wall is limited. Other examples of conventional nail plates exist with different shapes and configurations. However, multiple nail plates may be required to fully protect utilities within a wall. Therefore, a need exists for systems and methods for protecting a utility line from penetrating objects.

### SUMMARY

In embodiments, a method protects a utility line positioned within a wall. The wall includes two adjacent studs, which support a wall surface. The utility line extends vertically between the studs. The method includes positioning a utility line protection plate between the studs, covering at least a portion of the utility line with the utility line protection plate, and mounting the utility line protection plate between the studs.

In some embodiments, positioning a utility line protection plate between the studs may include positioning the entire utility line protection plate completely between the studs. Further, covering at least a portion of the utility line with the utility line protection plate may include covering a substantial portion of the utility line with the utility line protection plate. Also, mounting the utility line protection plate between the studs may include attaching the utility line protection plate to each of the studs.

In some embodiments, attaching the utility line protection plate to each of the studs may include moving a first movable bracket associating with the plate, attaching the first movable bracket to a first stud, moving a second movable bracket associated with the plate, and attaching the second movable bracket to a second stud. For example, moving a first movable bracket may include sliding the first movable bracket with reference to at least one first retaining device associated with the plate until a first attachment portion of the first movable bracket is positioned adjacent to the first stud, and attaching the first movable bracket to the first stud may include driving a first fastener through the first attachment portion into the first stud, while moving a second movable bracket may include sliding the second movable bracket with reference to at least one second retaining device associated with the plate until a second attachment portion of the second movable bracket is positioned adjacent to the second stud, and attaching the second movable bracket to the second stud may include driving a second fastener through the second attachment portion into the second stud.

In embodiments, the method also may include covering the studs with the wall surface to enclose the utility line within the wall, the utility line protection plate sandwiched between the utility line and the wall surface.

In other embodiments, a system protects a utility line positioned within a wall between two adjacent wall studs. The system includes a plate portion and a number of brackets. The plate portion is sized to be positioned between the two adjacent wall studs. The brackets are movably associated with the plate portion. The brackets are suited for attaching the plate portion to the two adjacent wall studs.

In some embodiments, the plate portion may include a metal material. The plate portion may include a metal plate crimped along at least one longitudinal edge. The system also may include a protective sleeve positioned over at least one longitudinal edge of the plate portion.

In embodiments, the system includes a number of retaining devices associated with the plate portion, and each bracket is slidably associated with one of the retaining devices. The retaining devices may include slits formed through the plate portion. Each bracket may be threaded through the slits.

In embodiments, each bracket is threaded through the plate portion. Each bracket may have at least one end portion suited for attaching the bracket to one of the studs. Each bracket may include a body portion and an attachment portion. The body portion may be slidably associated with a retaining device of the plate portion to associate the bracket with the plate portion, and the attachment portion may extend from the body portion in a direction suited for attaching the attachment portion to one of the studs.

In embodiments, each bracket includes a strip that extends through at least one retaining device associated with the plate portion and an angled end suited for attaching to the stud. The brackets may be associated with the plate portion such that the angled ends of adjacent brackets are located on opposite sides of the plate portion.

Other methods, systems, and apparatuses according to various embodiments of the invention will become apparent with respect to the remainder of this document.

### BRIEF DESCRIPTION OF THE FIGURES

The present disclosure may be better understood with reference to the following figures. Matching reference numerals designate corresponding parts throughout the figures, and components in the figures are not necessarily to scale.

FIG. 1 is a perspective view of a system of protecting a utility line from a penetrating object, illustrating the system in an example environment, according to an embodiment of the invention.

FIG. 2 is plan view of another embodiment of a system of protecting a utility line from a penetrating object.

FIG. 3 is a perspective view of the embodiment of the system shown in FIG. 2, illustrating the system in a partially folded configuration.

FIG. 4 is a side view of the embodiment of the system shown in FIG. 2, illustrating the system in a folded configuration.

FIG. 5 is a block diagram illustrating an example method of protecting a utility line from a penetrating object in accordance with an embodiment of the invention.

FIG. 6 is a perspective view of another embodiment of a system of protecting a utility line from a penetrating object, illustrating an embodiment of a connecting device.

FIG. 7 is a perspective view of yet another embodiment of a system of protecting a utility line from a penetrating object, illustrating an additional embodiment of a connecting device.

FIG. 8 is a front perspective view of another embodiment of a system of protecting a utility line from a penetrating object.

FIG. 9 is a front view of the embodiment of the system shown in FIG. 8.

FIG. 10 is a rear view of the embodiment of the system shown in FIG. 8.

FIG. 11 is a block diagram illustrating another embodiment of a method of protecting a utility line from a penetrating object.

### DETAILED DESCRIPTION

Described below are embodiments of systems and methods of protecting a utility line from a penetrating object. Within this disclosure, the term “utility line” generally refers to a wire, tube, pipe, cable, line, duct, connection or other component associated with a system, such as an HVAC system, a plumbing system, an electrical system, a communications system, a stereo system, or a network system, among other systems or combinations thereof. The disclosed systems and methods may be suited for protecting these and other utility lines from penetrating objects, such as nails, screws, spikes, or other construction components, that may penetrate, puncture, sever, damage, or otherwise engage the utility line, such as during construction, renovation, or improvement of a home, office, or other building.

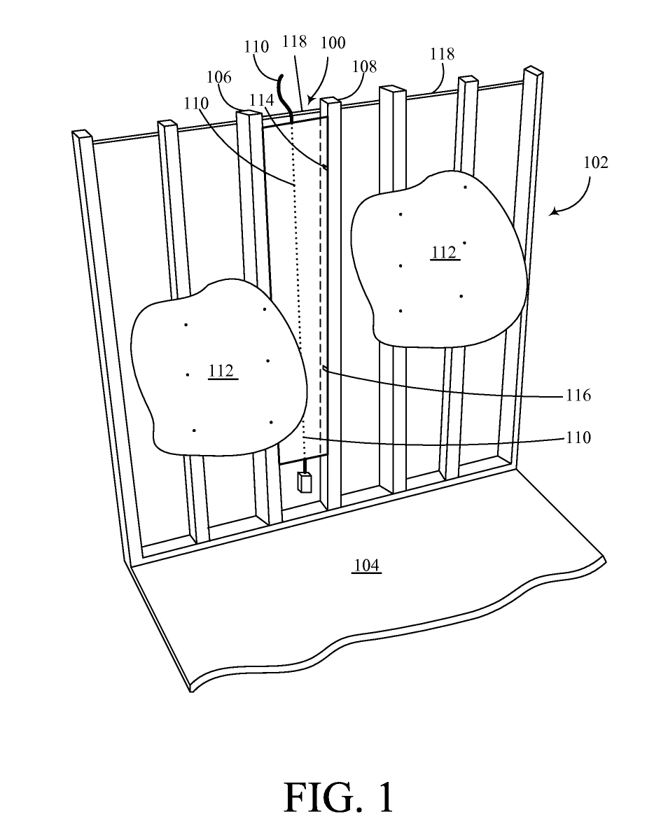

FIG. 1 is a perspective partial view of an embodiment of a system 100 for protecting a utility line from a penetrating object, illustrating the system 100 positioned in a wall 102 of a building 104. As shown, the wall 102 generally includes a number of wall studs, such as 106 and 108, which serve as a skeleton for supporting wall surfaces positioned on either side of the studs. In cases in which the wall 102 is positioned on an exterior of the building 104, the wall studs may support an exterior wall surface 118, such as a sheet of oriented strand board (OSB), on the exterior of the building 104, and an interior wall surface 112, such as a sheet of sheetrock or particle board, on the interior of the building 104. In cases in which the wall 102 is positioned on the interior of the building 104, the wall studs may support interior wall surfaces 112 on both sides of the wall 102. Thus, a relatively enclosed wall 102 may be formed that hides the wall skeleton and any components housed therein.

For example, utility lines 110 are typically positioned within various walls 102 throughout the building 104. Many of the utility lines 110 are housed within walls 102 on the exterior of the building 104, although utility lines 110 also may be housed within walls 102 on the interior of the building 104. A utility line 110 can be positioned between two adjacent studs 106 and 108 extending vertically through the wall 102 as shown in FIG. 1. For the purposes of this disclosure, the term “extending vertically through the wall” indicates the utility line 110 is wholly positioned between two adjacent studs, extending in a generally upright direction. When so positioned, the utility line 110 may be completely encased in the space between the two adjacent wall studs 106, 108. However, although other orientations are possible. For example, the utility line 110 may be horizontally positioned between the two adjacent wall studs 106, 108, or the utility line 110 may horizontally traverse more than two adjacent wall studs, such as be passing through openings formed in the studs.

The system 100 can be installed within the wall 102 to protect the utility line 110 from a penetrating object inserted through one of the wall surfaces. Generally, the system 100 is positioned between the utility line 110 and the interior wall surface 112 to protect the utility line 110 from penetrating objects inserted through the interior wall surface 112, as shown in FIG. 1. However, the system 100 also may be positioned between the utility line 110 and the exterior wall surface 118 to protect the utility line 110 from penetrating objects inserted through the exterior wall surface 118. Systems 100 also may be positioned on both sides of the utility line 110 to protect the utility line 110 from penetrating objects inserted through wall surfaces on either side of the studs.

In cases in which the utility line 110 extends vertically through the wall 102 between two adjacent wall studs 106, 108 as shown in FIG. 1, the system 100 may be positioned between the two adjacent studs 106, 108 extending vertically through the wall 102. In cases in which the utility line 110 has another orientation within the wall 102, the system 100 may have the other orientation within the wall 102. Regardless, the system 100 may at least partially, substantially, or completely cover the utility line 110 to protect the utility line 110 from a penetrating objects inserted through the wall surface. For example, if a nail or screw is driven through the interior wall surface 112 in FIG. 1, the system 100 may inhibit or prevent the nail or screw from penetrating, puncturing, severing, damaging, or otherwise engaging the utility line 110.

The system 100 may be attached to the studs with a series of mounting devices. The mounting devices mount various portions of the system 100 to the wall studs 106, 108. When the system 100 is mounted, the system 100 may become completely embedded 102 between the studs 106, 108 below their outermost surfaces. Thus, the system 100 may not impede the application of wall surfaces 112, 118 to the studs 106, 108. However, other configurations are possible. In the embodiment illustrated in FIG. 1, the mounting devices are L-shaped clips 114, 116, although other mounting devices can be used.

Further, although the system 100 is typically mounted within a wall 102 of a building 104, the system 100 also can be mounted in other locations where utility lines 110 may be exposed to possible engagement by penetrating objects, such as within a floor, ceiling, or other location. The configuration and arrangement of the components shown and described with respect to FIG. 1 is shown by way of example only, and other configurations and arrangements of system components can exist in accordance with other embodiments of the invention.

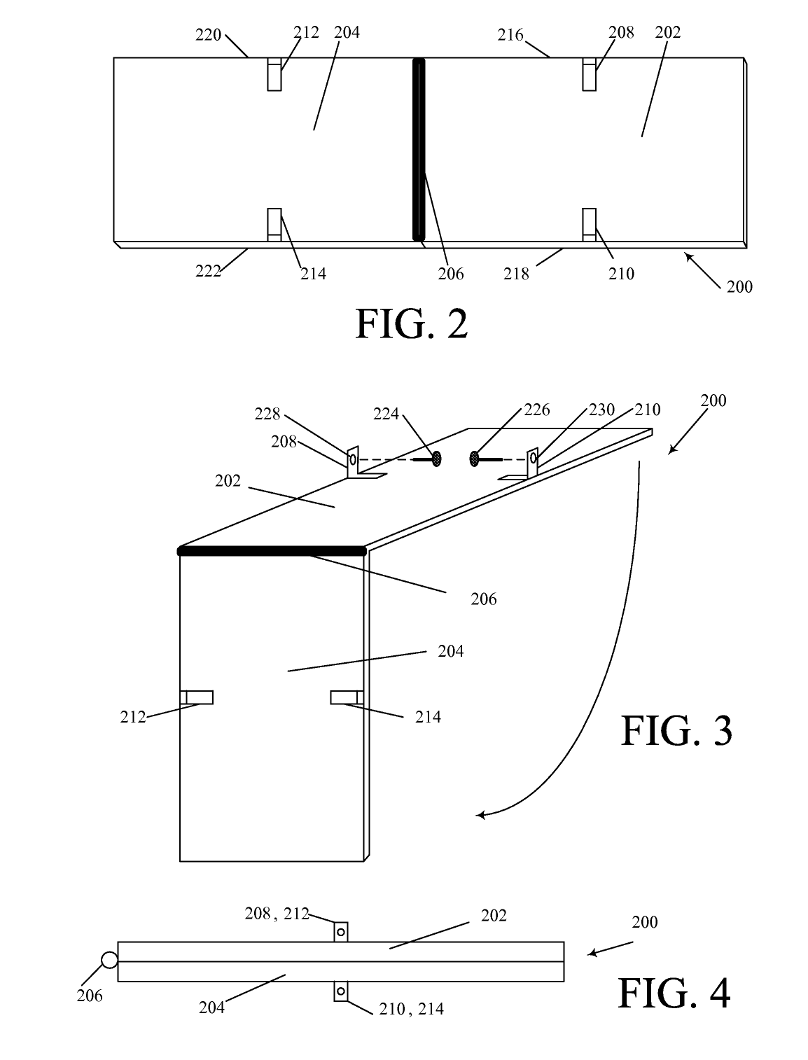

FIG. 2 illustrates an example system or utility line protection plate 200, similar to system 100 shown in FIG. 1. The utility line protection plate 200 shown in FIG. 2 includes two similar rectangularly-shaped, relatively flat plate pieces 202, 204. In this example, each of the two plate pieces 200, 202 can be connected to each other with at least one connecting device, such as a hinge 206, which permits the two plate pieces 202, 204 to be moved with respect to each other. The utility line protection plate 200 is shown in an extended orientation or position. In one embodiment, two plate pieces 202, 204 can be made from approximately ¼ inch (0.6 cm) thick relatively hard material, such as steel or a peg board. Various metals or other substantially strong and durable materials can be used for a utility line protection plate.

Other shapes of plate pieces can be used with other embodiments, including shapes such as square, circular, triangular, or other geometries. In some embodiments, the relatively flat plates can be replaced with angular or channeled pieces, or other shapes of configurations depending on the available space between adjacent wood studs or within a wall, ceiling, or floor.

Since adjacent wall studs, similar to 106 and 108 in FIG. 1, may be different widths apart and different heights depending on the building construction, approximate dimensions of a utility line protection plate can be modified accordingly to fit between different wall stud configurations. An example dimension for a system or utility line protection plate shown in FIG. 2 can be approximately 8 inches (20.3 cm) wide by 8 feet (2.4 m) high by ¼ inches (0.6 cm) thick, with each plate piece having a dimension of approximately 8 inches (20.3 cm) wide by 4 feet (1.2 m) high by ¼ inches (0.6 cm) thick. Other width dimensions for a system embodiment or utility line protection plate can be approximately 12 inches (30.5 cm), 16 inches (40.6 cm), or 24 inches (61 cm). Other height dimensions for a system embodiment or utility line protection plate can be approximately 9 feet (2.7 m) and 10 feet (3.0 m). Other thickness dimensions for a utility line protection plate can include various gauge sizes of sheet metal, including 3, 4, 5, or 6 gauge sheet metal. Other approximate width, height, and thickness dimensions, and shapes for a system embodiment or utility line protection plate can exist according to other embodiments of the invention.

The connecting device or hinge 206 permits the two plate pieces 202, 204 to be moved with respect to each other as shown in FIG. 3. The utility line protection plate 200 in FIG. 3 is shown in another extended orientation or position. In this embodiment, the hinge 206 is mounted adjacent to an edge of each of the plate pieces 202, 204.

When the two plate pieces 202, 204 are moved into a parallel relation to each other as shown in FIG. 4, the utility line protection plate 200 folds roughly in half, in a collapsed orientation or position, for ease of transportation. Likewise, as shown in FIGS. 1 and 2, when the two plate pieces 202, 204 are oriented in a coplanar relation to each other, the utility line protection plate 200 can be positioned over various utility lines running between two vertically oriented and spaced apart wall studs, such as 106, 108, in a wall of a building, such as the wall 102 in building 104 in FIG. 1.

In another embodiment, more than one hinge or connecting device can be used to connect the two plate pieces 202, 204 together such that the plate pieces 202, 204 can be moved with respect to each other similar to the movement shown in FIG. 3. In yet another embodiment, any number of hinges or connecting devices can be used to connect multiple plate pieces together to permit the overall extended configuration of plate pieces to be folded into a relatively smaller, collapsed configuration. In any instance, when a utility line protection plate or multiple plates comprising the utility line protection plate is in a collapsed orientation or position, the utility line protection plate or multiple plates can be transported relatively easier than when the utility line protection plate or multiple plates are in an extended orientation or position.

Mounting devices, such as L-shaped clips 208, 210, 212, 214, are shown mounted adjacent to the respective lateral sides 216, 218, 220, 222 of the rectangular-shaped plate pieces 202, 204. In the example shown in FIG. 2, the L-shaped clips 208, 210, 212, 214 can be made from steel, and the clips 208, 210, 212, 214 can be welded or otherwise connected to a surface of the utility line protection plate 200. Various metals or other substantially strong and durable materials can be used for mounting devices.

In the embodiment shown, each of the L-shaped clips 208, 210, 212, 214 are spaced approximately half way down each respective lateral side 216, 218, 220, 222 of the plate pieces 202, 204. In other embodiments, a mounting device or L-shaped clip can be adapted to mount to any portion of a plate piece, and may be further adapted to mount to any portion of a wall, ceiling, or floor of a building.

At least one nail, bolt, or other fastening device, such as nails 224, 226, can be mounted through a hole, such as 228, 230, associated with L-shaped clips 208, 210. Other similar sized holes (not shown) can be machined in each of the other L-shaped clips for use with a nail, bolt, or other fastening device, such as nails 224, 226. Each of the mounting devices or L-shaped clips 208, 210, 212, 214 can be adapted to mount to both a surface of one of the plate pieces, such as 202, 204, and at least one wall stud, such as 106, 108 in FIG. 1. For example, nail 224, can be positioned in hole 228 of L-shaped clip 208, and the clip 208 can be mounted to a wall stud, such as 106, by driving the nail 224 into the wall stud 106 to mount a portion of the plate piece 202 to the wall stud 106. Likewise, nails similar to 224 and 226 can be positioned in other holes for the other clips 210, 212, 214, and the clips 210, 212, 214 can be mounted to a wall stud, such as 106 or 108, by driving the respective nails into the wall studs 106, 108 to mount other portions of the plate pieces 202, 204 to the wall studs 106, 108. Other embodiments of mounting devices or L-shaped clips can utilize other hole configurations or other devices to mount the plate pieces, such as 202, 204, to a wood stud, such as 104, 106.

In one embodiment, a utility line protection plate such as 200 can be in a fully extended position, where the plate pieces 202, 204 are substantially coplanar with each other as shown in FIG. 1, and nails such as 224, 226 can be mounted through holes 228, 230 in clips 208, 210 to mount the utility line protection plate 200 to wood studs, such as 106, 108.

In another embodiment, a utility line protection plate such as 200 can be in a partially extended position, where the plate pieces 202, 204 are neither coplanar with each other nor are the plate pieces 202, 204 substantially parallel with each other as shown in FIG. 4, and nails such as 224, 226 can be mounted through holes 228, 230 in clips 208, 210 to mount the utility line protection plate 200 to wood studs, such as 106, 108.

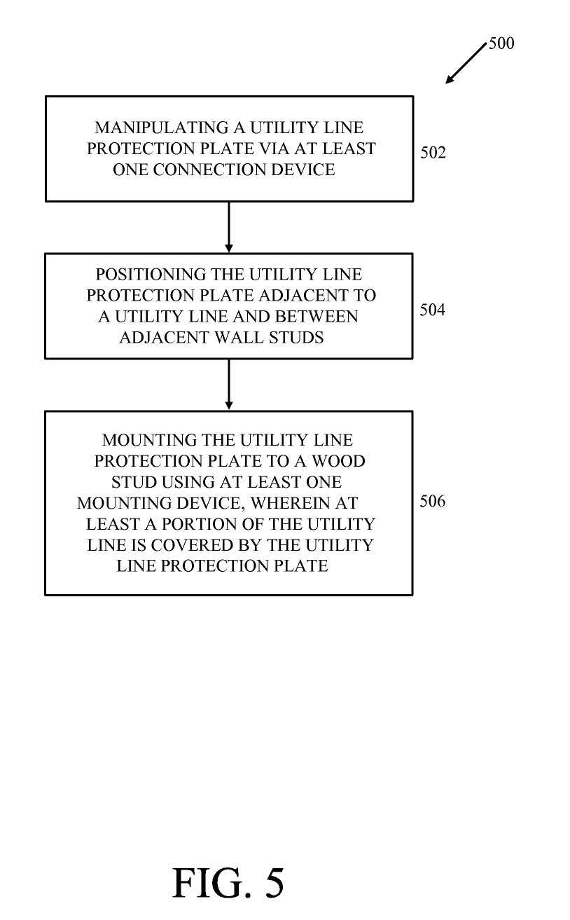

FIGS. 2-4 illustrate examples of a system or utility line protection plate in accordance with an embodiment of the invention. Other examples and configurations for a system or utility line protection plate can exist in other embodiments of the invention. Using a system or utility line protection plate as illustrated in FIGS. 1-4, the example method 500 described in FIG. 5 can be implemented. The method 500 of FIG. 5 begins at block 502.

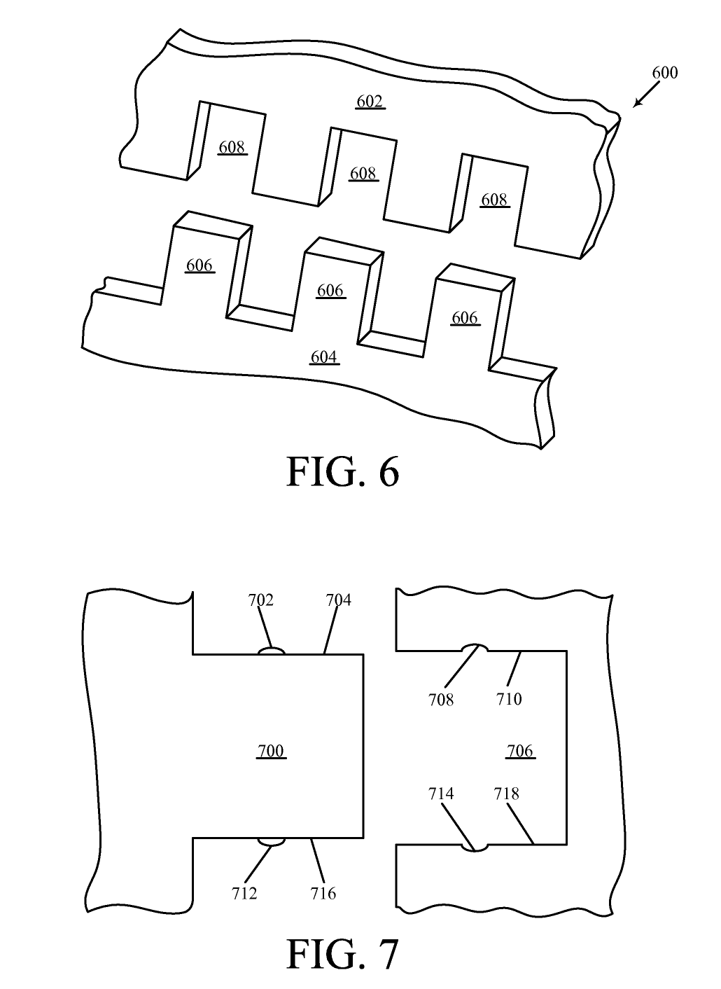

In block 502, a utility line protection plate is manipulated via at least one connecting device. In this embodiment, a utility line protection plate, such as 200 in FIG. 2, can be manipulated from a collapsed orientation, shown in FIG. 4, to any number of extended orientations, shown in FIGS. 1-3. By way of at least one connecting device, such as a hinge 206 shown in FIG. 2, the utility line protection plate 200 can be manipulated into an extended orientation or position. In one embodiment, the at least one connecting device can be an interconnecting device, such as a tongue and corresponding groove, shown as 606 and 608 in FIG. 6.

Block 502 is followed by block 504, in which the utility line protection plate is positioned adjacent to a utility line and between adjacent wood studs associated with a wall. In this embodiment, the utility line protection plate 200 can be inserted within a wall and between adjacent wall studs, such as 106 and 108 in FIG. 1, to cover a substantial portion of a utility line, such as 110, within the wall. In one embodiment, a second utility line protection plate can be positioned adjacent to the utility line and between adjacent wood studs, such that the second utility line protection plate covers another portion of the utility line than the initial utility line protection plate.

Block 504 is followed by block 506, in which at least one mounting device is used to mount the utility line protection plate to at least one wood stud, wherein at least a portion of the utility line is covered by the utility line protection plate. In this embodiment, one or more mounting devices, such as an L-shaped clip 208 in FIG. 2, can be used to mount a portion of the utility line protection plate 200 to a portion of a wood stud, such as 106 in FIG. 1. For example, the utility line protection plate 200 in FIGS. 2-4 utilize a series of 4 L-shaped clips, 208, 210, 212, 214, to mount the plate 200 to adjacent wood studs. The method 500 ends at block 506.

The methods disclosed herein are by way of example only, and other methods in accordance with embodiments of the invention can include other elements or steps, including fewer or greater numbers of element or steps than the example methods described herein.

Another example system in accordance with an embodiment of the invention is shown in FIG. 6. In FIG. 6, an example system or utility line protection plate 600, similar to systems 100, 200 shown in respective FIGS. 1 and 2, can be installed with respect to a wall of a building, similar to those shown in FIG. 1. The utility line protection plate 600 shown in FIG. 6 includes two similar rectangular-shaped, relatively flat plate pieces 602, 604 (which are shown in part in FIG. 6, but can be a similar size to those in FIG. 1 or 2). In this example, each of the two plate pieces 602, 604 can be interconnected with each other via one or more interconnecting devices, such as a relatively square-shaped tongue 606 and corresponding square-shaped groove 608. The interconnecting devices, such as 606, 608, can permit the two plate pieces 602, 604 to be moved with respect to each other as well as to be fit relatively snug to each other. In this example, at least three tongue and corresponding grooves are shown. In other embodiments, any number of interconnecting devices, such as a tongue and grooves, can exist.

In one embodiment, interconnecting devices can be a series of devices, for instance, multiple tongues and corresponding grooves evenly spaced adjacent to the edges of the adjoining flat plate pieces 602, 604. In another embodiment, interconnecting devices can be a series of devices, for example, multiple tongues and corresponding grooves spaced at different distances adjacent to the edges of the adjoining flat plate pieces 602, 604.

In other embodiments, interconnecting devices can have other configurations or shapes, such as triangular, rectangular, oval, circular, polygonal, or any combination thereof. Essentially, any configuration or shape used for an interconnecting device should permit two adjoining plate pieces, such as 602, 604, to be moved with respect to each other as well as to be fit relatively snug to each other.

In one embodiment, a pair of interconnecting devices, such as a relatively square-shaped tongue and corresponding square-shaped groove, can include a rounded surface and detent structure which permits the adjoining plate pieces, such as 602, 604, to be “snap” fit together, yet permitting the plate pieces to be moved with respect to each other as well as to be fit relatively snug to each other. For example, a rounded surface could be machined or mounted to an edge of a tongue, such as 606, associated with one plate piece, such as 602. A corresponding detent structure can be machined or mounted to an edge of a corresponding groove, such as 608, associated with another plate piece, such as 604, such that when the tongue 606 and corresponding groove 608 are mounted together, the rounded surface mounts to the corresponding detent structure.

An example of a rounded surface and corresponding detent structure for an example tongue and groove combination is shown in FIG. 7. The example combination can be used with a tongue and groove shown in FIG. 6, or with any other type of interconnecting device described herein. As shown in FIG. 7, a tongue 700 can have a rounded surface 702 on a lateral side 704, and groove 706 can have a corresponding detent structure 708 within a lateral side 710 of the groove 706. This example shows an opposing rounded surface 712 and detent structure 714 associated with opposing lateral sides 716, 718 of the tongue 700 and groove 706.

In other embodiments, any number of similar types of devices, surfaces, or structures can be used to permit adjoining plate pieces to be “snap” fit together, yet permitting the plate pieces to be moved with respect to each other as well as to be fit relatively snug to each other. In one embodiment, a rounded surface can be a ball or spherical shape embedded in the surface of a tongue or other interconnecting device. In another embodiment, a detent structure can be a trough or notch machined in the surface of a groove or other interconnecting device. In other embodiments, a rounded surface and detent structure can be interchanged, or used in various combinations together or with other similar types of devices, surfaces, or structures.

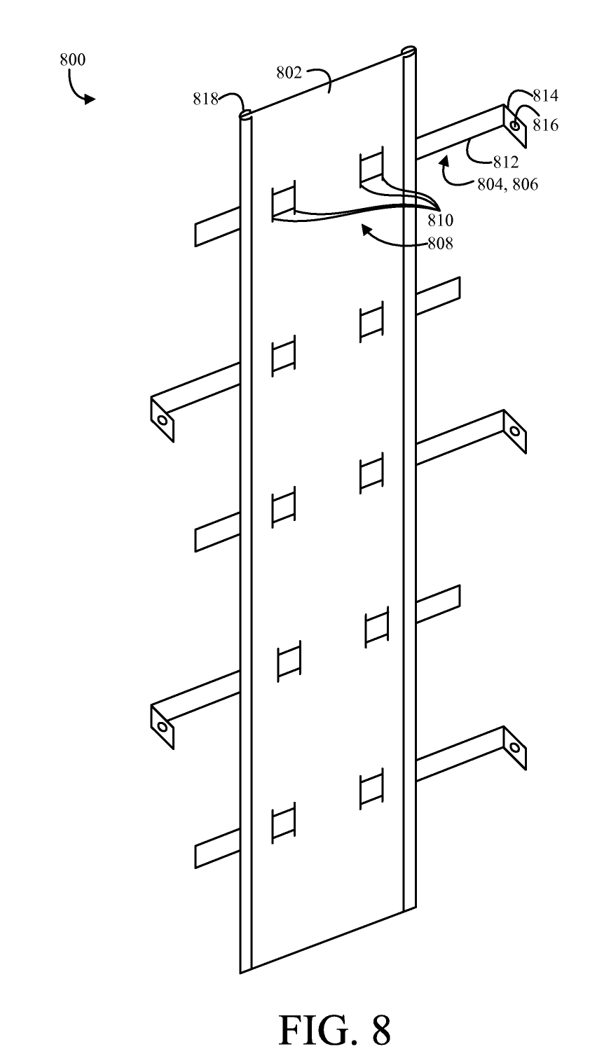

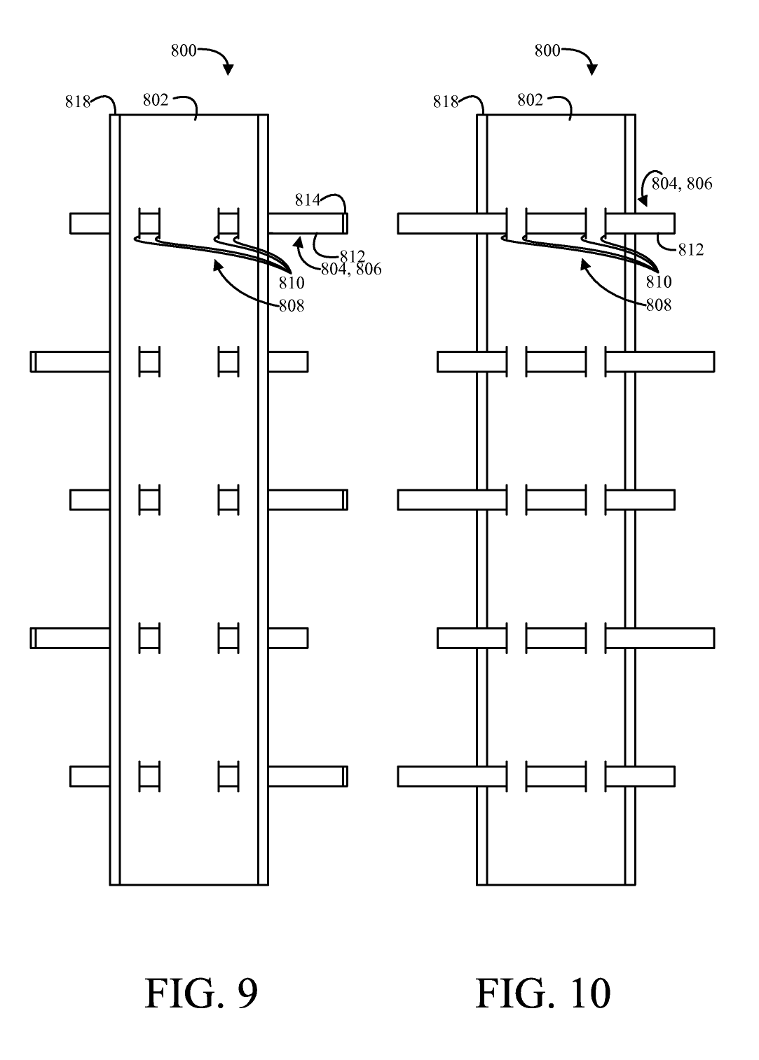

FIG. 8 is a perspective view of another embodiment of a system 800 of protecting a utility line from a penetrating object, and FIGS. 9 and 10 are plan views of the system 800, illustrating the system 800 from the front and rear, respectively. The system 800 generally includes at least one plate piece 802. The plate piece 802 may be sized and shaped for positioning within a wall, such as the wall 102 shown in FIG. 1. In most embodiments, the plate piece 802 is sized and shaped for positioning within the wall 102 completely between two adjacent wall studs 106, 108. For example, a width of the plate piece 802 may be less than a distance between the two adjacent wall studs 106, 108, and a height of the plate piece 802 may be less than a height of the wall studs 106, 108 from floor to ceiling. The plate piece 802 also is sized and shaped for covering at least a portion of the utility line 110, and in some cases may be sized and shaped for covering a substantial portion of the utility line 110. For example, a width of the plate piece 802 may exceed a width of the utility line 110, and in some embodiments, a height of the plate piece 802 may be close to the height of the utility line 110 that is exposed between the wall studs 106, 108. Thus, when positioned in the wall 102 between the studs 106, 108, the plate piece 802 may cover a substantial portion of the utility line 110.

As shown, the plate piece 802 may be relatively flat and rectangular in shape, although other shapes and configurations are possible. For example, the plate piece 802 may be square, circular, or triangular, among other shapes and geometries. The plate piece 802 also may be angled or channeled, among other shapes and configurations, depending on the available space between the adjacent studs 106, 108 or within the wall, ceiling, or floor.

Only one plate piece 802 is shown for the purpose of illustration, but in other embodiments more than one plate piece 802 may be provided. In such embodiments, the plate pieces 802 may be secured together with at least one connecting device, such as a hinge, joint, screw, or other fastener.

In embodiments, the plate piece 802 may be made from a relatively sturdy material, such as steel, that may resist the impact of a penetrating object. For example, the plate piece 802 may be a steel sheet having a thickness of about approximately ¼ inch (0.6 cm). Various metals or other substantially strong and durable materials may be used for the plate piece 802.

As mentioned above, the plate piece 802 may be associated with one or more mounting devices 804 suited for associating the plate piece 802 with the wall 102. The mounting devices 804 may have a configuration now known or later developed. The mounting devices 804 may be associated with any portion of the plate piece 802, such the top, bottom, or sides of the plate piece 802, or combinations thereof. For example, the mounting device 804 may be a string associated with the top of the plate piece 802 that permits hanging the plate piece 802 between the studs 106, 108. The mounting device 804 also may be a ground support configured for supporting the plate piece 802 from the ground, the ground support having a slot for receiving a lower edge of the plate piece 802 or a plurality of buttresses for capturing the plate piece 802 between them.

In the illustrated embodiment, the one or more mounting devices 804 include a number of brackets 806 associated with the plate piece 802. The brackets 806 may be suited for attaching the plate piece 802 to the wall studs 106, 108. Because the space between adjacent wall studs 106, 108 may have different widths depending on the building, the brackets 806 may be movable. For example, each bracket 806 may be slidably associated with a retaining device 808, which in turn is associated with the plate portion 802. The retaining device 808 may be formed through the plate portion 802 or may be attached to the plate portion 802. For example, the retaining device 808 in the illustrated embodiment is a plurality of slits or scores 810 that are formed through the plate portion 802. The slits or scores 810 facilitate supporting the plate piece 802 about the bracket 806. As shown in the illustrated embodiment, the bracket 806 may be threaded through the slits or scores 810 to associate the bracket 806 with the plate portion 802. The illustrated embodiment includes two pairs of slits or scores 810, although other configurations are possible. However, the bracket 806 may be attached to the plate piece 802 in other manners. For example, the plate piece 802 may have opposed receiving channels that extend from a surface of the plate piece 802, and the bracket 806 may be slidably positioned in the receiving channels. Other examples of suitable retaining devices 808 can include, but are not limited to, slots, folds, creases, loops, O-shaped pieces, L-shaped pieces, U-shaped pieces, V-shaped pieces, C-shaped pieces, or other devices operable to facilitate sliding or otherwise moving the bracket 806 with respect to a plate piece 802.

Each bracket 806 may have at least one end portion suited for attaching the bracket 806 to one of the studs. For example, each bracket 806 may have a body portion 812 and an attachment portion 814. The body portion 812 may be associated with the retaining device 808 to associate the bracket 806 with the plate portion 802, and the attachment portion 814 may extend from the body portion 812 in a direction suited for attaching the attachment portion 814 to the stud. For example, in the illustrated embodiment the body portion 812 is a strip that is threaded through the slits or scores 810 in the plate piece 802, and the attachment portion 814 is an angled end that extends from the strip. To attach the system 800 to the studs 106, 108, the brackets 806 may be moved with reference to the retaining devices 808 until the attachment portions 814 are adjacent to the studs, and the attachment portions 814 may be attached to the studs to secure the system between them. For example, the angled end or other attachment portion 814 may include an opening 816 for receiving a fastener, such as a nail, as shown in the illustrated embodiment. The fastener may be inserted through the opening 816 to attach the attachment portion 814 to the stud.

In the illustrated embodiment, each bracket 806 has one attachment portion 814. To attach the bracket 806 to the stud, the bracket 806 may be moved until the attachment portion 814 is adjacent to the stud and thereafter may be attached to the stud. Such a configuration may be employed in cases in which the distance between the studs varies or is not known in advance. In such an embodiment, the brackets 806 may be associated with the plate portion 802 such that the attachment portions 814 of adjacent brackets 806 are located on opposite longitudinal sides of the plate portion 802. Thus, adjacent brackets 806 may be attached to opposite studs, such as in an alternating fashion, facilitating secure mounting. However, other configurations are possible. For example, the brackets 806 may be sized to span the distance between adjacent studs, in which case the brackets 806 may have attachment portions 814 located on both ends for attaching to both studs.

In embodiments, the plate piece 802 may be a metal plate that is crimped along at least one longitudinal edge. The crimp may protect a user's hand during installation of the system 800. A protective sleeve 816 also may be positioned over at least one longitudinal edge of the plate portion 802, either as an alternative or in addition to the crimp. The protective sleeve 816 may be formed from a plastic material. The protective sleeve 816 may protect a user's hand during installation of the utility line protection plate 200.

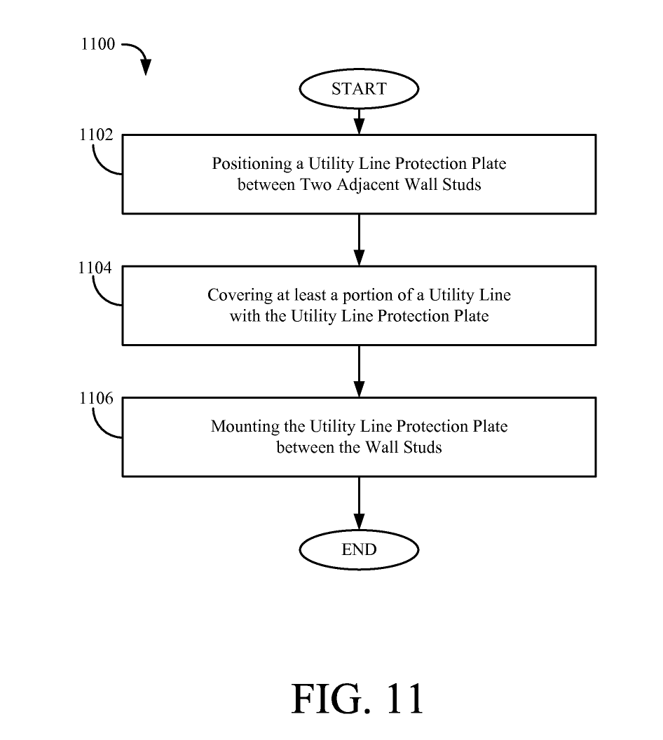

FIG. 11 is a block diagram illustrating an embodiment of a method 1100 of protecting a utility line positioned within a wall. The wall generally may be of the type described above with reference to FIG. 1. The wall includes two adjacent studs, which support a wall surface. The utility line extends vertically between the studs. The method begins in block 1102.

In block 1102, a utility line protection plate is positioned between the studs. The utility line protection plate may be any embodiment of a utility line protection plate described above. In embodiments, the entire utility line protection plate is positioned completely between the studs. In block 1104, at least a portion of the utility line is covered with the utility line protection plate. In some embodiments, a substantial portion of the utility line is covered.

In block 1106, the utility line protection plate is mounted between the studs. In some embodiments, the utility line protection plate is attached to each of the studs. For example, the plate may be attached to the studs by moving brackets associating with the plate and attaching the brackets to the studs. The brackets may be moved by sliding the brackets with reference to retaining devices associated with the plate until an attachment portion of the bracket is positioned adjacent to the stud. A fastener may be driven through the attachment portion into the stud. So that the plate is completely supported, some of the brackets may be attached to one of the studs, while other brackets may be attached to the other stud. Thereby, the plate may be completely mounted in the wall between the studs, covering the utility line.

In embodiments, the method also may include covering the studs with the wall surface to enclose the utility line within the wall. Thereby, the utility line protection plate becomes sandwiched in the wall between the utility line and the wall surface.

A method of manufacturing a utility line protection plate is also disclosed. The method comprises cutting a metal plate, dulling or otherwise modifying an edge of the metal plate, stamping or otherwise modifying the plate to form (or mount) at least one slit or retaining device, and positioning a bracket through the slit or retaining device to associate the bracket with the plate. In certain embodiments of the method, dulling or otherwise modifying an edge of the metal plate may comprise one or more of the following: crimping the edge of the metal plate, and placing a protective sleeve over the edge of the metal plate. In embodiments, the method may further comprise forming the bracket by forming a strip having an angled end.

The methods disclosed herein are by way of example only, and other methods in accordance with embodiments of the invention can include other elements or steps, including fewer or greater numbers of element or steps than the example methods described herein.

While particular embodiments of systems and methods for protecting a utility line from a penetrating object have been disclosed in detail in the foregoing description and figures for purposes of example, those skilled in the art will understand that variations and modifications may be made without departing from the scope of the disclosure. All such variations and modifications are intended to be included within the scope of the present disclosure, as protected by the following claims.

At least the following is claimed:

1. A method of protecting a utility line positioned within a wall, the wall comprising two adjacent studs, the utility line extending vertically between the studs, the studs supporting a wall surface, the method comprising:
positioning a utility line protection plate between the studs;
covering at least a portion of the utility line with the utility line protection plate; and
mounting the utility line protection plate between the studs.

2. The method of claim 1, wherein positioning a utility line protection plate between the studs comprises positioning the entire utility line protection plate completely between the studs.

3. The method of claim 1, wherein covering at least a portion of the utility line with the utility line protection plate comprises covering a substantial portion of the utility line with the utility line protection plate.

4. The method of claim 1, wherein mounting the utility line protection plate between the studs comprises attaching the utility line protection plate to each of the studs.

5. The method of claim 1, wherein:
positioning a utility line protection plate between the studs comprises positioning the entire utility line protection plate completely between the studs; and
mounting the utility line protection plate between the studs comprises attaching the utility line protection plate to each of the studs.

6. The method of claim 5, wherein attaching the utility line protection plate to each of the studs comprises:
moving a first movable bracket associating with the plate;
attaching the first movable bracket to a first stud;
moving a second movable bracket associated with the plate; and
attaching the second movable bracket to a second stud.

7. The method of claim 6, wherein:
moving a first movable bracket comprises sliding the first movable bracket with reference to at least one first retaining device associated with the plate until a first attachment portion of the first movable bracket is positioned adjacent to the first stud;
attaching the first movable bracket to the first stud comprises driving a first fastener through the first attachment portion into the first stud;
moving a second movable bracket comprises sliding the second movable bracket with reference to at least one second retaining device associated with the plate until a second attachment portion of the second movable bracket is positioned adjacent to the second stud; and
attaching the second movable bracket to the second stud comprises driving a second fastener through the second attachment portion into the second stud.

8. The method of claim 7, further comprising covering the studs with the wall surface to enclose the utility line within the wall, the utility line protection plate sandwiched between the utility line and the wall surface.

9. A system for protecting a utility line positioned within a wall between two adjacent wall studs, comprising:
a plate portion sized to be positioned between the two adjacent wall studs; and
a plurality of brackets movably associated with the plate portion, the brackets suited for attaching the plate portion to the two adjacent wall studs.

10. The system of claim 9, wherein the plate portion comprises a metal material.

11. The system of claim 9, wherein the plate portion comprises a metal plate crimped along at least one longitudinal edge.

12. The system of claim 9, further comprising a protective sleeve positioned over at least one longitudinal edge of the plate portion.

13. The system of claim 9, further comprising a plurality of retaining devices associated with the plate portion, each bracket slidably associated with one of the retaining devices.

14. The system of claim 13, wherein the plurality of retaining devices comprise slits formed through the plate portion.

15. The system of claim 14, wherein each bracket is threaded through the slits.

16. The system of claim 9, wherein each bracket is threaded through the plate portion.

17. The system of claim 9, wherein each bracket has at least one end portion suited for attaching the bracket to one of the studs.

18. The system of claim 9, wherein each bracket comprises:
a body portion slidably associated with a retaining device of the plate portion to associate the bracket with the plate portion; and
an attachment portion extending from the body portion in a direction suited for attaching the attachment portion to one of the studs.

19. The system of claim 9, wherein each bracket comprises:
a strip that extends through at least one retaining device associated with the plate portion; and
an angled end suited for attaching to the stud.

20. The system of claim 19, wherein the brackets are associated with the plate portion such that the angled ends of adjacent brackets are located on opposite sides of the plate portion.
